(19) United States
(12) Patent Application Publication
(10) Pub. No.: US 2025/0140956 A1
(43) Pub. Date: May 1, 2025

(54) DETERMINING AN INTERNAL BATTERY TEMPERATURE BASED ON A DETERMINED BATTERY TEMPERATURE CHANGE OVER TIME FROM AN INITIAL TEMPERATURE CONDITION

(71) Applicant: EATON INTELLIGENT POWER LIMITED, Dublin 4 (IE)

(72) Inventors: Ajay C S, Nagercoil (IN); Saiful HAQ, Lucknow (IN); Manoj VERMA, Pune (IN); Fiaz SHAIK, Dublin (IE)

(21) Appl. No.: 18/834,331

(22) PCT Filed: Mar. 29, 2022
(86) PCT No.: PCT/EP2022/058244

§ 371 Date: Jul. 30, 2024

(30) Foreign Application Priority Data
Feb. 4, 2022 (IN) 202211006021

(51) Int. Cl. H01M 10/48; G01K 7/42

(52) U.S. Cl. CPC H01M 10/486; G01K 7/42; G01K 2217/00

(57) ABSTRACT

Some embodiments relate to a method for determining an internal temperature of a battery. The method includes obtaining an initial temperature condition of the battery indicative of battery temperature at an initial time, receiving an electrical current in the battery at a given time after the initial time, and receiving an ambient temperature associated with the battery at the given time. The method includes determining a heat generation rate in the battery based on an internal resistance of the battery and on the received current, and determining a temperature change of the battery at the given time from the initial time, the temperature change being determined based on the initial temperature condition and the heat generation rate. The internal temperature of the battery is determined based on the determined temperature change and the ambient temperature.

### CROSS-REFERENCE TO RELATED APPLICATIONS

This application is a national phase filing under 35 C.F.R. § 371 of and claims priority to PCT Patent Application No. PCT/EP2022/058244, filed on Mar. 29, 2022, which claims the priority benefit under 35 U.S.C. § 119 of Indian Patent Application number 202211006021, filed on Feb. 4, 2022, the contents of which are hereby incorporated in their entireties by reference.

### TECHNICAL FIELD

The presently disclosed subject matter relates to determining an internal temperature, e.g. core temperature, of a battery, such as a lithium ion battery. In particular, the internal temperature is determined by determining a temperature change in the battery over a given time period from an initial temperature condition.

### BACKGROUND

Uninterruptible Power Supply (UPS) systems are generally used for short power interruptions that are caused by a wide variety of unforeseen circumstances. That is, UPS systems or apparatus provide emergency power to a load when the input power source or mains power fails. However, UPS systems may also be used in different cases, such as for peak-load shifting, demand response, generator substitution, peak shaving, and frequency regulation applications.

The batteries of such UPS systems, e.g. lithium ion batteries, need to be capable of providing relatively large levels of peak power for sustained periods of time, varying from a few minutes to several hours depending on the application, while maintaining a safe internal temperature, e.g. core temperature.

It is desirable to have knowledge of the internal or core temperature of batteries in general—and, in particular, lithium ion batteries in UPS systems—for several reasons. For instance, battery performance may be determined by the core temperature, where a loss of capacity and power may be identified based thereon. The core temperature may be used to estimate the state of health (SoH) of a cell, as a generated solid electrolyte interphase that causes battery degradation accelerates at high temperatures. Also, battery core temperature monitoring can help in detecting thermal run-away scenarios, which often occurs at higher temperatures, where the high temperature triggers exothermic reactions in the batteries.

It is challenging to measure internal core temperatures of a (lithium ion) battery. Often, battery surface temperature—which can be measured more readily—is used as a proxy for core temperature; however, surface temperature is in general significantly lower than the core temperature. Existing methods to estimate battery core temperature from battery surface temperature suffer from high hardware and manufacturing costs, and high wiring, data transmission and storage costs. This is because of the relatively large number of thermo couples that need to be installed (one for each cell). These existing methods are also less suitable for brown-field applications where batteries are already installed in the field.

It is against this background to which the presently disclosed subject matter is set.

### SUMMARY OF THE DISCLOSURE

According to an aspect of the presently disclosed subject matter there is provided a computer-implemented method for determining an internal temperature of a battery. The method comprises obtaining an initial temperature condition of the battery indicative of battery temperature at an initial time. The method comprises receiving current data indicative of electrical current in the battery at a given time after the initial time. The method comprises receiving ambient temperature data indicative of ambient temperature associated with the battery at the given time. The method comprises determining a heat generation rate in the battery based on an internal resistance of the battery and on the received current data. The method comprises determining a temperature change of the battery at the given time from the initial time, the temperature change being determined based on the obtained initial temperature condition and the determined heat generation rate. The method comprises determining the internal temperature of the battery based on the determined temperature change and the received ambient temperature data.

The method may comprise obtaining an electro-thermal model describing the temperature change of the battery as a function of time in dependence on heat generation rate in the battery. Determining the temperature change of the battery at the given time may comprise evaluating the electro-thermal model at the given time based on the obtained initial temperature condition and the determined heat generation rate.

The electro-thermal model may describe the temperature of the battery as a function of distance from a core of the battery.

Determining the internal temperature of the battery may comprise evaluating the electro-thermal model at a given distance from the core less than a distance to a surface of the battery. Optionally, the temperature at the core of the battery may be determined as the internal temperature of the battery.

The method may comprise determining a surface temperature of the battery at the given time. Determining the surface temperature may comprise evaluating the electro-thermal model at a distance equal to a distance from the core to the surface of the battery to determine the temperature change of the surface of the battery at the given time from the initial time. Determining the surface temperature may comprise determining the surface temperature of the battery based on the determined temperature change of the surface and the received ambient temperature data.

The electro-thermal model may include a plurality of parameters describing electrical, thermal and geometric properties of the battery.

Values of the plurality of parameters may be obtained via a training stage for training the electro-thermal model to determine the internal temperature of the battery. The values of the plurality of parameters may be obtained using historical data for the battery.

The method may comprise performing the training stage. The training stage may comprise initialising the plurality of parameters with initial values. The training stage may comprise evaluating the electro-thermal model with the initial parameter values and with the historical data to obtain an estimated surface temperature of the battery over a given time period. The training stage may comprise comparing the estimated surface temperature with a measured surface temperature of the battery over the given time period obtained from the historical data. The training stage may comprise updating the initial values of the plurality of parameters based on a difference between the estimated and measured surface temperatures to obtain current values of the parameters.

The training stage may comprise repeating steps of: evaluating the electro-thermal model with the current parameter values and with the historical data to obtain the estimated surface temperature over the given time period; comparing the estimated surface temperature with the measured surface temperature over the given time period; and, updating the current values of the plurality of parameters based on the difference between the estimated and measured surface temperatures over the given time period, until a stop condition is satisfied.

The stop condition may be, or include, that the evaluating, comparing and updating steps have been repeated a prescribed threshold number of times. The stop condition may be, or include, that a difference between a sum of squared errors between the estimated and measured surface temperatures over the given time period is less than a prescribed threshold difference value.

Updating the current values of the plurality of parameters may include applying a trust region optimisation method.

The historical data may include measured values of current, voltage and surface temperature for the battery.

The historical data may include end-of-line testing data.

The electro-thermal model may be an analytic equation for the temperature change of the battery.

The analytic equation for the temperature change θ(x, t) of the battery may be given by:

$$θ ( x , t ) = \frac{\overline{\dot{q} ( t )} {L}^{2}}{2 {k}_{eff}} ( 1 - \frac{{x}^{2}}{{L}^{2}} + \frac{2}{Bi} ) + 4 {\sum }_{n = 1}^{∞} [ {θ}_{i} - \frac{\overline{\dot{q} ( t )}}{{k}_{eff} {λ}_{n}^{2}} ] \cdot [ \frac{sin ( {λ}_{n} L )}{2 {λ}_{n} L + sin ( 2 {λ}_{n} L )} ] cos {λ}_{n} x \cdot {e}^{- {αλ}_{n}^{2} t}$$

$$where$$

$$tan {λ}_{n} L = \frac{Bi}{{λ}_{n} L}$$

$$α = \frac{{k}_{eff}}{ρ {C}_{p}}$$

$$Bi = \frac{hL}{{k}_{eff}}$$

where t is time from the initial time, k_{eff} is an effective thermal conductivity of the battery, ρCₚ is a thermal capacity of the battery, x is a distance from a centre of an equivalent plane wall representing the battery, L is a half thickness of the equivalent plane wall, λₙ is an eigenvalue for a given n value of an infinite series obtained by converging tan λₙL=Bi/λₙL, θᵢ is an average temperature difference between the battery and ambient temperature at the initial time, h is a heat transfer coefficient between the battery surface and ambient, and \overline{\dot{q}(t)} is the heat generation rate in the battery.

In some examples, \overline{\dot{q}(t)} may be given by:

$$\overline{\dot{q} ( t )} = \frac{μ {R}_{in}}{φ t} {\int }_{0}^{t} {I ( t )}^{2} dt$$

where Rᵢₙ is the internal resistance of the battery, I(t) is the electrical current at the given time, and μ is a correction factor for the internal resistance Rᵢₙ. Rᵢₙ is estimated over definite intervals, e.g. from 3 to 6 months, from the voltage and the current data.

In some examples, θᵢ may be set based on an average temperature θ̅(̅τ̅)̅ of the battery at the end of a previous time in which the internal temperature of the battery was determined. In some examples, θ̅(̅τ̅)̅ may be given by:

$$\overline{θ ( τ )} = \frac{\overline{\dot{q} ( τ )} {L}^{2}}{3 {k}_{eff}} ( 1 + \frac{3}{Bi} ) + 4 {\sum }_{n = 1}^{∞} \{ \frac{1}{{λ}_{n} L} [ {θ}_{i} - \frac{\overline{\dot{q} ( τ )}}{{k}_{eff} {λ}_{n}^{2}} ] \cdot [ \frac{sin ( {λ}_{n} L )}{2 {λ}_{n} L + sin ( 2 {λ}_{n} L )} ] \cdot {e}^{- {αλ}_{n}^{2} τ} \}$$

where τ=NΔt and Δt is a time interval between consecutive observations of the temperature change. N is the total number of observations in a given cycle.

The method may comprise determining the internal resistance of the battery. The internal resistance may be determined based on a voltage across the battery under a no discharge condition of the battery, a voltage across the battery under discharge, and the current in the battery during discharge.

The initial temperature condition may be obtained as an average temperature of the battery at the end of a previous time period in which the internal temperature, and optionally surface temperature, of the battery was determined.

The previous time (period) may correspond to a time (period) that the battery operated in a certain operational mode.

The initial time may correspond to a time at which the battery changes to operating in one operational mode from another operational mode.

The battery may be a lithium ion battery.

The battery may be part of an Uninterruptible Power Supply (UPS) system.

The method may comprise providing an output in dependence on the determined internal temperature. Optionally, the output may comprise a warning if the determined internal temperature exceeds a prescribed threshold. Optionally, the output may comprise a control signal to automatically change an operational mode of the battery if the determined internal temperature exceeds the prescribed threshold.

According to another aspect of the presently disclosed subject matter there is provided a non-transitory, computer-readable storage medium storing instructions thereon that when executed by a processor cause the processor to perform a method as defined above.

According to another aspect of the presently disclosed subject matter there is provided a system for determining an internal temperature of a battery. The system comprises one or more processors configured to: obtain an initial temperature condition of the battery indicative of battery temperature at an initial time; receive current data indicative of electrical current in the battery at a given time after the initial time, and receive ambient temperature data indicative of ambient temperature associated with the battery at the given time; determine a heat generation rate in the battery based on an internal resistance of the battery and on the received current data; determine a temperature change of the battery at the given time from the initial time, the temperature change being determined based on the obtained initial temperature condition and the determined heat generation rate; and, determine the internal temperature of the battery based on the determined temperature change and the received ambient temperature data.

The system may be partly or fully implemented in a device comprising the battery. The system may be partly or fully implemented in an edge processing device. The system may be partly or fully implemented in a battery management system for monitoring operation of the battery.

### BRIEF DESCRIPTION OF THE DRAWINGS

Examples of the presently disclosed subject matter will now be described with reference to the accompanying drawings, in which:

FIG. 1 schematically illustrates a battery and a battery monitoring system in accordance with an example of the presently disclosed subject matter;

FIG. 2(a) schematically illustrates the battery of FIG. 1, the battery having arbitrary shape, and FIG. 2(b) schematically shows a plane wall that is used as an equivalent to the battery of FIG. 1 in an example of the presently disclosed subject matter;

FIG. 3 shows a plot of battery surface temperature over time using the system of FIG. 1; and,

FIG. 4 shows the steps of a method performed by the system of FIG. 1 in accordance with an example of the presently disclosed subject matter.

### DETAILED DESCRIPTION

The presently disclosed subject matter provides a system and method for determining or estimating an internal temperature, e.g. core temperature, of a battery, such as a lithium ion battery. The method can use both analytic and optimisation techniques to provide battery internal temperature determinations. The method involves determining a temperature rise in the battery over a period of time from an initial temperature condition to determine battery internal temperature at a given time, where the method needs only relatively readily available data such as electric current, voltage and ambient temperature to perform the determination.

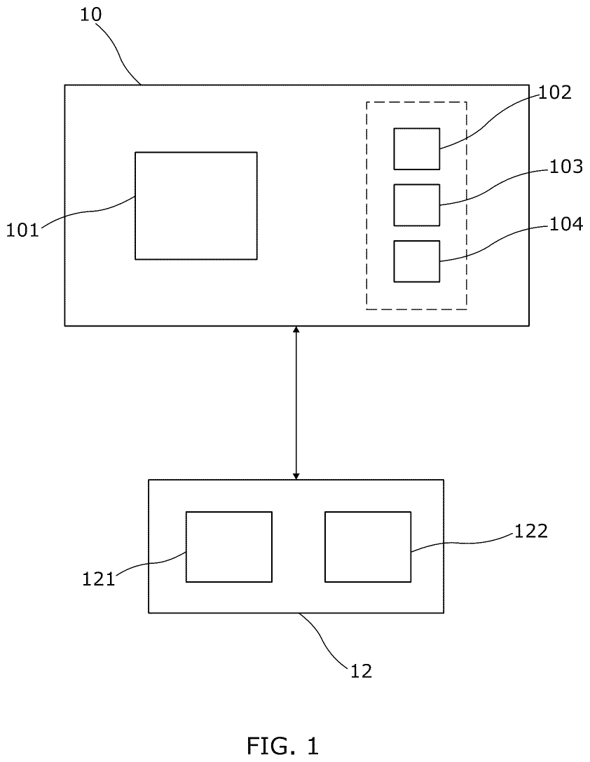

FIG. 1 schematically illustrates an uninterruptible power supply (UPS) system 10 including a lithium ion battery 101 for providing power to a load (not shown). The UPS system 10 may provide emergency power to the load when an input power source or mains power fails, and/or the UPS system 10 may be utilised for other applications such as peak-load shifting, demand response, generator substitution, peak shaving, and frequency regulation application. The UPS system 10 may be incorporated into a device (not shown) including the load for which the battery 101 provides power.

In accordance with the known art, in the lithium ion battery 101 lithium ions move from a negative electrode of the battery through an electrolyte to a positive electrode of the battery during discharge of the battery 101, and the lithium ions move back in the other direction during charging of the battery 101. The negative electrode of a lithium ion cell of the battery 101 may be formed from carbon, the positive electrode may be a metal oxide, and the electrolyte may be a lithium salt in an organic solvent.

The UPS system 10 may have a number of sensors associated therewith. In particular, the UPS system 10 includes a current sensor 102 for measuring electric current in the battery 101 (or a circuit branch including the battery 101). The UPS system 10 also includes a voltage sensor 103 for measuring the voltage across terminals of the battery 101. Furthermore, the UPS system 10 includes a temperature sensor 104 for measuring ambient temperature associated with the battery 101. For instance, the ambient (air) temperature may be a measurable temperature nearest to the battery 101. That is, the ambient temperature may be the temperature of an area surrounding the battery so far as it is reasonably practicable to measure.

FIG. 1 also schematically illustrates a battery monitoring system (BMS) 12 for monitoring the UPS system 10 and, in particular, for monitoring operation of the battery 101. The BMS 12 is configured to receive signals from the sensors 102, 103, 104 associated with operation of the battery 101. The BMS 12 includes one or more computer processors 121 for performing determinations of battery performance, based at least on part on the received sensor signals. The BMS 12 also includes a memory device 122 for storing sensor data and other parameters needed for determining battery performance, as well as instructions for the processor 121 to perform calculations to determine battery performance.

In general, the system 12 may be in the form of any suitable computing device, for instance one or more functional units or modules implemented on one or more computer processors. Such functional units may be provided by suitable software running on any suitable computing substrate using conventional or customer processors and memory. The one or more functional units may use a common computing substrate (for example, they may run on the same server) or separate substrates, or one or both may themselves be distributed between multiple computing devices. A computer memory may store instructions for performing the methods performed by the controller, and the processor(s) may execute the stored instructions to perform the methods.

The presently disclosed subject matter is advantageous in that it provides a system and method for determining an internal temperature of a battery, such as the lithium ion battery 101 of the UPS system 10, that does not require relatively expensive hardware to make such measurements. In previous, known approaches, thermo couples may be used to determine battery core temperature. The hardware costs of such previous approaches are relatively high given the large number of thermo couples that are needed, in particular one for each cell. These approaches also have relatively high labour and manufacturing costs associated with installing such thermo couples, as well as high wiring, data transmission and storage costs associated therewith.

The presently disclosed subject matter obviates the need for such hardware by providing an approach that requires only readily available measurements associated with battery operation to determine battery internal temperature, such as electric current, voltage, and ambient temperature. In particular, the presently disclosed subject matter provides an approach that can use analytic, and optionally optimisation, approaches to determine a rise in battery internal temperature over a time period based on the above, readily-available data and an initial temperature condition of the battery, to determine battery internal temperature at a given time, e.g. real-time internal temperature determination. This approach will be discussed in greater detail below.

The presently disclosed subject matter is also advantageous in that prior knowledge of various properties of the battery are not needed in order to determine battery internal temperature. This means that battery internal temperature can be determined for batteries where such information is not necessarily readily available, for instance batteries that are already installed in the field. Examples of the presently disclosed subject matter utilise a model that describes battery internal temperature in dependence on parameters indicative of various properties of the battery, such as geometric, thermal, and electrical properties. In cases in which values of at least some of the relevant parameters are unknown, the presently disclosed subject matter provides an approach for estimating values of the parameters based on historical data, or other available data, so that the model can then be used to determine battery internal temperature, as will be discussed in greater detail below.

It is highly challenging to measure the battery core temperature and it is relatively expensive to measure the surface temperature using hardware. The presently disclosed subject matter determines or estimates battery core temperature, and optionally battery surface temperature, via a hybrid (Physical-Neural network) model trained by available data. In particular, the presently disclosed subject matter estimates surface/core temperature based on ambient conditions and on thermal and geometric properties of the battery, which are either known, assumed, or trained using available data.

In one example, an analytical equation is derived for obtaining a temperature difference or change θ(x, t) between the battery 101 and ambient of the battery 101, and is given by

$$θ ( x , t ) = \frac{\overline{\dot{q} ( t )} {L}^{2}}{2 {k}_{eff}} ( 1 - \frac{{x}^{2}}{{L}^{2}} + \frac{2}{Bi} ) + 4 {\sum }_{n = 1}^{∞} [ {θ}_{i} - \frac{\overline{\dot{q} ( t )}}{{k}_{eff} {λ}_{n}^{2}} ] \cdot [ \frac{sin ( {λ}_{n} L )}{2 {λ}_{n} L + sin ( 2 {λ}_{n} L )} ] cos {λ}_{n} x \cdot {e}^{- {αλ}_{n}^{2} t}$$

$$where$$

$$tan {λ}_{n} L = \frac{Bi}{{λ}_{n} L}$$

$$α = \frac{{k}_{eff}}{ρ {C}_{p}}$$

$$Bi = \frac{hL}{{k}_{eff}}$$

where t is time, k_{eff} is an effective thermal conductivity of the battery, ρCₚ is a thermal capacity of the battery, x is a distance from a centre of an equivalent plane wall representing the battery, L is a half thickness of the equivalent plane wall, λₙ is an eigenvalue for a given n value of an infinite series obtained by converging tan λₙL=Bi/λₙL, θᵢ is an average temperature difference between the battery and ambient temperature at the initial time, h is a heat transfer coefficient between the battery surface and ambient, and \overline{\dot{q}(t)} is the heat generation rate in the battery.

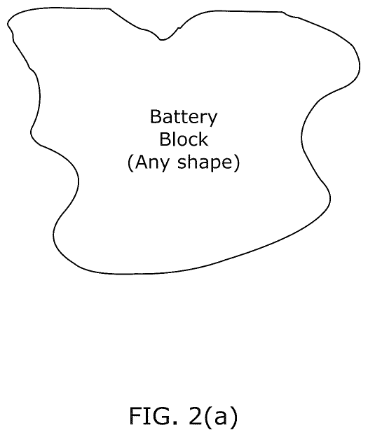

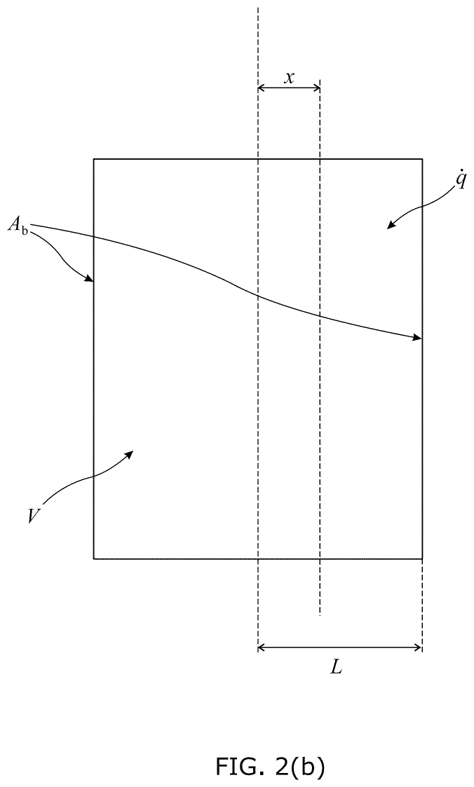

A battery of arbitrary shape (as illustrated schematically in FIG. 2(a)) can be converted to an equivalent plane wall (as illustrated in FIG. 2(b)) by using the volume φ and surface area ξ of the battery. It may be seen that the equation for θ(x, t) is therefore an expression for determining or estimating the temperature change in the battery 101 over time at any point within the battery. In particular, in the expression for (x, t), x=0 corresponds to the core of the battery 101, i.e. the centre or middle part of the battery, and x=L corresponds to the surface of the battery 101. It is therefore apparent that the expression for θ(x, t) may be used to determine the temperature difference between ambient temperature and the temperature of any specific part of the battery 101, such as the battery core temperature (by setting x=0), the battery surface temperature (by setting x=L), or the temperature of any other internal part of the battery (by setting x such that 0<x<L, as desired).

A derivation of the expression for θ(x, t) above is provided at the end of this section. In particular, it is a nonlinear mathematical model that is derived based on the physics of the battery by applying appropriate boundary conditions. The analytical model takes (measured) current and voltage as inputs, and gives the internal (e.g. core) and/or surface temperature as output.

In the above, the half width L of the equivalent plane wall having the same volume to surface area ratio as the battery may be given by L=φ/ξ, where φ is the volume of the battery 101 and ξ is the surface area of the battery 101.

The variable \overline{\dot{q}(t)} is the time averaged heat generation rate in the battery 101 at a given time instant t, given by

$$\overline{\dot{q} ( t )} = \frac{μ {R}_{in}}{φ t} {\int }_{0}^{t} {I ( t )}^{2} dt$$

where Rᵢₙ is the internal resistance of the battery, I(t) is the electrical current at the given time, and μ is a correction factor for the internal resistance Rᵢₙ.

The internal resistance can be directly obtained from open circuit voltage (OCV), voltage, and current during battery discharge as follows:

$${R}_{in} = \frac{{V}_{ocv} - V}{I}$$

where V_{ocv} is voltage measured across terminals of the battery 101 under a no discharge condition, V is voltage measured across terminals of the battery 101 under discharge, and I is the electric current measured during discharge. V_{ocv} and V are measured at the same charge level of the battery.

In the general case, at least some of the various geometric, thermal and electrical parameters of the defined electro-thermal model outlined above may be unknown for the particular battery under consideration. Therefore, in some examples values of at least some of the various model parameters (L, ρCₚ, h, φ, Rᵢₙ, k_{eff}, μ) may need to be determined or estimated prior to the model being able to be used to perform real-time determinations of the internal and/or surface temperatures of the battery 101.

The model parameter values may be estimated based on already-available or historical data. For instance, such historical data may include end-of-line test data and/or master data in the field. In particular, although such data may not include data relating to internal battery temperatures under various operation of the battery, this data may include data relating to surface temperatures under various modes of battery operation. As noted above, the defined electro-thermal model can be used to determine battery surface temperatures (as well as internal temperatures), in particular by setting x=L in the expressions above. As such, historical data relating to battery surface temperatures under various operational modes may be used to train the defined electro-thermal model, i.e. to estimate the model parameter values.

In a first step of a training stage or process to train the electro-thermal model, the parameters of the model that are to be estimated or optimised are initialised. The parameters may be assigned initial values, which may be based on historical values for similar applications, e.g. via a look-up, or in any other suitable manner. Indeed, these initial values may be obtained from end-of-line test data or similar. Note that values for at least some of the model parameters for the particular battery 101 under consideration may be known a priori, and so these known model parameters will not be optimised as part of the training stage.

These initial parameter values are then used in the above-defined analytical equation for θ(x, t) to estimate battery surface temperature, i.e. by setting x=L, at a given time. The battery surface temperature may be estimated at several time steps across a given time period, e.g. corresponding to a time period that the battery spends in a particular mode of operation, or over a charge and discharge cycle of the battery.

The estimated battery surface temperature(s) over time from the electro-thermal model are then compared to the historical data, i.e. measured values of battery surface temperature under the given operating conditions or operational mode, e.g. from end-of-line test data or measurements from the field of operation of the battery 101.

The difference between the estimated and measured surface temperatures are then used to adjust or optimise the model parameter values (that are to be optimised) as part of an iterative process. In particular, estimated and measured surface temperatures may be obtained at several time steps from an initial time step, which may correspond to the battery changing to a certain operational mode, to a final step, which may correspond to the battery stopping operation in that certain operational mode, e.g. by changing to another operational mode or being switched off.

In one example, the difference between the estimated and measured surface temperatures is determined by calculating a sum of squared errors between the estimated and measured surface temperatures at each time step. If the difference is less than a prescribed threshold or, in particular, if the change in the sum of squared errors (from a previous iteration) is less than a prescribed threshold, then the model parameter values are adjusted or updated.

In one example, the model parameter values are updated by applying a trust region optimisation method. In particular, the size of the trust region may be calculated and then the trust region subproblem may be solved, in a manner that will be understood by the skilled person. That is, a parametric search algorithm with physics-driven bounds may be performed to adjust parameter values.

The optimisation process to estimate the model parameters may be performed in any suitable manner. For instance, a machine learning process such as a neural network architecture, e.g. artificial neural network, may be used to estimate the model parameters.

The parameters are varied such that there is a close match between time response of the surface temperature (average of temperature obtained at multiple locations in the surface) obtained from test data and that of the simulated model at x=L. The parameters are finalised such that they may be taken forward to the thermal model in the predictive algorithm for estimating internal temperature of the battery 101. In this way, the model may be trained on surface temperature estimations, but then can be deployed to estimate battery internal temperature (as well as battery surface temperature).

The process of estimating the surface temperature using current model parameter values, comparing the results against measured surface temperature (from historical data), and adjusting the parameter values based on the difference may be repeated in an iterative manner until a stop condition is satisfied. For instance, the stop condition may be that a prescribed threshold number of iterations have been performed, or that the difference between the estimated and measured values is sufficiently small according to an appropriately defined metric. The number of iterations performed before the stop condition is reached can vary, but may be of the order of tens or hundreds of iterations.

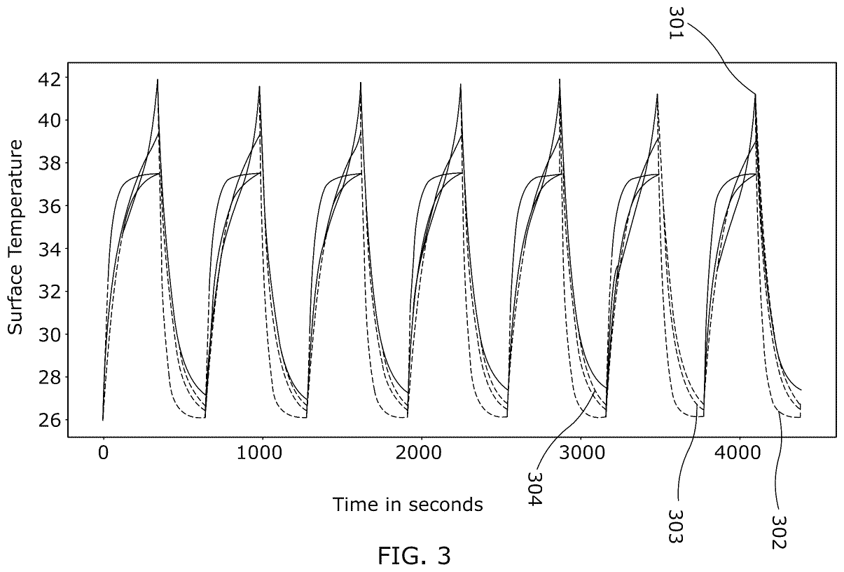

FIG. 3 shows plots of battery surface temperature over time to illustrate iterations of the training stage of the electro-thermal model. In particular, FIG. 3 shows how the battery surface temperature varies over charging and discharging cycles for a UPS battery, namely how the surface temperature increases during discharge and decreases during charging. Specifically, FIG. 3 shows how the surface temperature based on measured (historical) data 301 varies over time, and shows how estimated surface temperature using the electro-thermal model varies over time for a second iteration 302, a third iteration 303, and a final iteration 304, of the training stage. As may be seen, the estimated surface temperature more closely matches the measured surface temperature as the number of iterations increases.

It will be understood, therefore, that the approach of the presently disclosed subject matter benefits from utilising a multi-physics (electro-thermal) model for heat generation that is agnostic to the geometry and chemistry of the particular battery under consideration, with the parameters of the model being able to be trained for the particular battery under consideration. Indeed, simultaneous optimisation of lithium ion battery electrical, thermal and/or geometric parameters is performed based on historical data, or otherwise available data, particularly relating to battery surface temperature evolution in one or more battery operational modes.

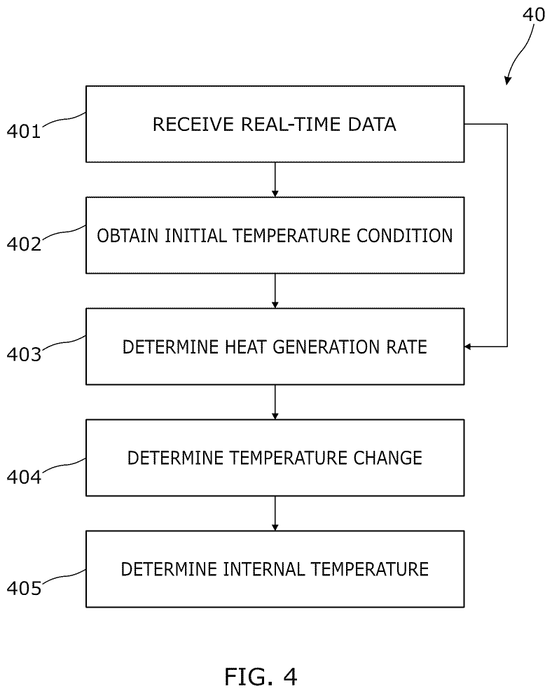

The trained electro-thermal model may then be used to perform real-time determinations of the internal temperature of the battery 101 over time. FIG. 4 shows steps of a method 40 that may be performed by the system 10 to determine battery internal temperature. At step 402, the method 40 involves receiving current data indicative of electrical current in the battery 101 at a given time after the initial time, e.g. at a particular time step. For instance, this current data may be received from the current sensor 102. Furthermore, the method 40 involves receiving ambient temperature data indicative of ambient temperature associated with the battery 101 at the given time. This temperature data may be received from the temperature sensor 104. Other data such as voltage data may also be received. In particular, this received data may be real-time data in the sense that it is indicative of real-time operation of the battery 101.

At step 402, the method 40 involves obtaining an initial temperature condition of the battery 101 indicative of battery temperature at an initial time. The initial time may be selected to be any suitable time. In one example, the initial time corresponds to a time at which there is a change in the operational mode that the battery 101 is operating in. The operating modes of the battery 101 may include a charging cycle, a floating mode, and/or a discharging cycle.

The initial temperature condition may be reflective of battery temperature from a previous cycle of battery operation and, in particular, an indicative battery temperature from a previous period during which the electro-thermal model was implemented to determine battery temperature. In one example, the average battery temperature at the end of a particular mode of operation is calculated and then used as the initial temperature condition for the next operational mode. In particular, the average temperature θ̅(̅τ̅)̅ of the battery 101 at the end of a previous time period, e.g. previous operational mode, in which the temperature of the battery 101 was determined may be given by

$$\overline{θ ( τ )} = \frac{\overline{\dot{q} ( τ )} {L}^{2}}{3 {k}_{eff}} ( 1 + \frac{3}{Bi} ) + 4 {\sum }_{n = 1}^{∞} \{ \frac{1}{{λ}_{n} L} [ {θ}_{i} - \frac{\overline{\dot{q} ( τ )}}{{k}_{eff} {λ}_{n}^{2}} ] \cdot [ \frac{sin ( {λ}_{n} L )}{2 {λ}_{n} L + sin ( 2 {λ}_{n} L )} ] \cdot {e}^{- {αλ}_{n}^{2} τ} \}$$

where τ=NΔt is the time period of an operational mode, N is the number of observations in an operational mode (i.e. the number of different time steps at which the temperature is estimated), and Δt is a time interval between consecutive observations of the temperature change. The initial temperature condition may be set in any other suitable manner.

The method may involve receiving a signal indicative that the operational mode of the battery 101 is changing or has changed, in order to prompt the initial temperature condition to be changed or updated, for instance using the expression for θ̅(̅τ̅)̅ above. The received signal may simply be a direct signal from the battery monitoring system that the operational mode has changed. Alternatively, the received signal may for instance be in the form of a voltage signal associated with the battery 101, e.g. from the voltage sensor 103, where a relatively sudden change in voltage may be assumed to correspond to a change of operational mode.

At step 403, the method involves determining a heat generation rate in the battery 101 based on an internal resistance of the battery 101 and on the received current data. The internal resistance of the battery 101 may be calculated based on a voltage across the battery 101 under a no discharge condition of the battery 101, a voltage across the battery 101 under discharge, and the current in the battery 101 during discharge. For instance, the internal resistance Rᵢₙ may be given by the expression outlined above, namely:

$${R}_{in} = \frac{{V}_{ocv} - V}{I}$$

The internal resistance may be calculated prior to the training stage and during the deployment over prescribed periods for estimating the model parameters, for instance.

The heat generation rate may be determined by integrating the heat loss due the internal resistance, and dividing by the time from the start of the present cycle under consideration. In particular, the heat generation rate \overline{\dot{q}(t)} may be given by the expression outlined above, namely:

$$\overline{\dot{q} ( t )} = \frac{μ {R}_{in}}{φ t} {\int }_{0}^{t} {I ( t )}^{2} dt$$

where I(t) is the electrical current at the given time, φ is the volume of the battery 101, and μ is a correction factor for the internal resistance Rᵢₙ.

This time-averaged heat generation rate may be calculated for discrete time intervals of the overall time period, e.g. overall time spent in a given operational mode. The time intervals may be of any suitable length, e.g. ten second intervals, with an average for each time interval being obtained.

At step 404, the method 40 involves determining a temperature change or rise of the battery 101 at the given time from the initial time, the temperature change being determined based on the obtained initial temperature condition and the determined heat generation rate. The temperature change θ(x, t) of the battery 101 may be given by the expression outlined above, namely:

$$θ ( x , t ) = \frac{\overline{\dot{q} ( t )} {L}^{2}}{2 {k}_{eff}} ( 1 - \frac{{x}^{2}}{{L}^{2}} + \frac{2}{Bi} ) + 4 {\sum }_{n = 1}^{∞} [ {θ}_{i} - \frac{\overline{\dot{q} ( t )}}{{k}_{eff} {λ}_{n}^{2}} ] \cdot [ \frac{sin ( {λ}_{n} L )}{2 {λ}_{n} L + sin ( 2 {λ}_{n} L )} ] {e}^{- {αλ}_{n}^{2} t} cos {λ}_{n} x$$

where θᵢ is the initial temperature condition and \overline{\dot{q}(t)} is the heat generation rate. This expression includes both a steady state temperature rise contribution and a transient temperature rise correction. In this way, a dynamic temperature determination is provided. The temperature change that is being estimated is for any desired part of the battery 101, e.g. an internal part of the battery 101 such as the core (centre or middle), and/or the surface temperature, depending on the value of x.

At step 405, the method 40 includes determining the temperature of the battery 101—in particular, the desired internal and/or surface temperature—based on the determined temperature change and the received ambient temperature data. In particular, the estimated temperature rise may be added to the observed ambient temperature to provide the overall battery temperature determination or estimation.

The method may involve providing an output based on the determination of battery temperature. For instance, this may be in the form of a recommendation to replace the battery 101 and/or control an operating environment or mode of the battery to guard against safety hazards and/or unplanned downtime in advance. These outputs may be triggered based on the determined battery temperature, or a rate or direction of change of battery temperature, relative to one or more threshold temperature values.

Many modifications may be made to the described examples without departing from the scope of the appended claims.

Although the described examples relate to a battery that is part of a UPS system, it will be understood that the presently disclosed subject matter is not limited to batteries that are part of UPS systems. Indeed, the presently disclosed subject matter may be implemented for a lithium ion battery providing power in any suitable context. Furthermore, it is noted that the presently disclosed subject matter may be implemented for batteries other that lithium ion batteries where battery internal temperature is of interest.

In the described example, the system for determining battery temperature in accordance with the presently disclosed subject matter is illustrated as being separate from a UPS (or other) system that includes the battery. It will be understood that the system implementing the described battery temperature determination method may be provided in any suitable location. For instance, the system may be provided as part of a device (with a load to be powered) comprising the battery. In other examples, the system may be provided on an edge processing device (e.g. in a data centre, in the cloud, etc.), or in a battery management system for monitoring operation of the battery.

In the following, a derivation of the analytic equation for determining battery internal temperature is provided.

The derivation is for a battery block of any shape (FIG. 2(a)), where the battery has volume V and surface area A_{b}. An equivalent plane wall representing the battery is illustrated in FIG. 2(b), where a half-width L of the plane wall in an x direction is given by L=V/A_{b}. A heat generation parameter \dot{q} of the battery is given by \dot{q}=Q/V, where Q is the total heat generated.

The general partial differential equation (PDE) for a temperature T of the heat generating battery over a period t is given by

$$\frac{{\partial }^{2} T}{\partial {x}^{2}} + \frac{\dot{q}}{k} = \frac{1}{α} \frac{\partial T}{\partial t}$$

Initial conditions are T=Tᵢ at t=0. Boundary conditions are that ∂T/∂x=0 at x=0 and ∂T/∂x=−(h/k) (T−T_{∞}) at x=L, where

$$φ = T - {T}_{∞} - \frac{\dot{q} L}{h}$$

The PDE then becomes

$$\frac{{\partial }^{2} φ}{\partial {x}^{2}} + \frac{\dot{q}}{k} = \frac{1}{α} \frac{\partial φ}{\partial t}$$

The initial conditions become φ=φᵢ at t=0. Boundary conditions are ∂φ/∂x=0 at x=0 and ∂φ/∂x=−(h/k) (T−T_{∞}) at x=L.

Considering the non-homogeneity, φ is defined as a sum of steady state and transient functions as follows

$$φ ( x , t ) = u ( x ) + v ( x , t )$$

where u(x) corresponds to the steady state value of T(x)−T_{∞}−(\dot{q}L/h) at the given boundary conditions. The one-dimensional (1D) steady state equation is given by

$$\frac{{\partial }^{2} u}{\partial {x}^{2}} + \frac{\dot{q}}{k} = 0$$

The corresponding boundary conditions are ∂u/∂x=0 at x=0 and ∂u/∂x=−(h/k) [u(L)+(qL/h)] at x=L.

Integrating the 1D steady state equation with respect to x gives

$$u = - \frac{\dot{q}}{2 k} {x}^{2} + {C}_{1} x + {C}_{2}$$

Applying the boundary conditions and solving for C₁ and C₂ gives C₁=0 and C₂=\dot{q}L²/2k, so that u is given by

$$u = - \frac{\dot{q} {L}^{2}}{2 k} ( 1 - \frac{{x}^{2}}{{L}^{2}} )$$

Substituting the above expression for φ(x, t) into the PDE gives

$$\frac{{\partial }^{2} u}{\partial {x}^{2}} + \frac{{\partial }^{2} v}{\partial {x}^{2}} + \frac{\dot{q}}{k} = \frac{1}{α} \frac{\partial v}{\partial t}$$

Using the determined expression for u then gives

$$\frac{{\partial }^{2} v}{\partial {x}^{2}} = \frac{1}{α} \frac{\partial v}{\partial t}$$

Boundary conditions are given by ∂v/∂x=0 at x=0 and ∂v/∂x=−(h/k) (T−T_{∞})−(q/k) at x=L. Realising v as a transient function of φ and considering v=T (x,t)−T_{∞}−(\dot{q}L/h) gives ∂v/∂x=−(h/k)v(L, t) at x=L.

Applying the method of separation of variables by assuming

v(x,t)=z(x)y(t)

and substituting into the above PDE for v gives

$$\frac{{z}^{″}}{z} = \frac{{y}^{′}}{y} = - {λ}^{2}$$

where λ² corresponds to the eigenvalue satisfying the equation

$$\frac{{z}^{″}}{z} = - {λ}^{2}$$

$${z}^{″} + {λ}^{2} = 0$$

$$z = A cos λ x + B sin λ x$$

$$\frac{{y}^{′}}{y} = - {λ}^{2}$$

$${y}^{′} + {λ}^{2} = 0$$

$$y = {Ce}^{- {αλ}^{2} t}$$

Applying the boundary conditions gives

$$- λ A sin λ L = - \frac{h}{k} A cos λ L$$

$$tan λ L = \frac{Bi}{λ L}$$

where Bi=hL/k.

Substituting the expressions for z and y into v=zy, the expression for φ becomes

$$φ ( x , t ) = {Ae}^{- {αλ}^{2} t} cos λ x + \frac{\dot{q} {L}^{2}}{2 k} ( 1 - \frac{{x}^{2}}{{L}^{2}} )$$

Applying the initial condition φ=φᵢ at t=0 and using the orthogonal property of eigenfunctions gives

$$A = \frac{4 sin λ L}{2 λ L + sin 2 λ L} [ {T}_{i} - {T}_{∞} - \frac{q}{k {λ}^{2}} ]$$

This gives the expression for φ(x, t) as

$$φ ( x , t ) = \frac{4 sin λ L}{2 λ L + sin 2 λ L} [ {T}_{i} - {T}_{∞} - \frac{q}{k {λ}^{2}} ] {e}^{- {αλ}^{2} t} cos λ x + \frac{\dot{q} {L}^{2}}{2 k} ( 1 - \frac{{x}^{2}}{{L}^{2}} )$$

The eigenvalue λ has multiple solutions for every π interval obtained by solving the equation

$$tan λ L = \frac{Bi}{λ L}$$

The resulting solution will be the sum of all of the eigenfunctions given by

$$φ ( x , t ) = \frac{\dot{q} {L}^{2}}{2 k} ( 1 - \frac{{x}^{2}}{{L}^{2}} ) + 4 {\sum }_{n = 1}^{∞} [ T - {T}_{∞} - \frac{q}{k {λ}_{n}^{2}} ] \cdot [ \frac{sin ( {λ}_{n} L )}{2 {λ}_{n} L + sin ( 2 {λ}_{n} L )} ] {e}^{- {αλ}_{n}^{2} t} cos {λ}_{n} x$$

Defining θ=T−T_{∞} as the temperature rise then gives

$$θ ( x , t ) = \frac{\dot{q} {L}^{2}}{2 k} ( 1 - \frac{{x}^{2}}{{L}^{2}} ) + 4 {\sum }_{n = 1}^{∞} [ {θ}_{i} - \frac{q}{k {λ}_{n}^{2}} ] \cdot [ \frac{sin ( {λ}_{n} L )}{2 {λ}_{n} L + sin ( 2 {λ}_{n} L )} ] {e}^{- {αλ}_{n}^{2} t} cos {λ}_{n} x$$

Average temperature θ̅(̅τ̅)̅ across the battery at any time instant τ is then given by

$$\overline{θ ( τ )} = \frac{1}{L} {\int }_{0}^{L} θ ( x , τ ) dx$$

$$\overline{θ ( τ )} = \frac{\overline{\dot{q} ( τ )} {L}^{2}}{3 {k}_{eff}} ( 1 + \frac{3}{Bi} ) + 4 {\sum }_{n = 1}^{∞} \{ \frac{1}{{λ}_{n} L} [ {θ}_{i} - \frac{\overline{\dot{q} ( τ )}}{{k}_{eff} {λ}_{n}^{2}} ] \cdot [ \frac{{sin}^{2} ( {λ}_{n} L )}{2 {λ}_{n} L + sin ( 2 {λ}_{n} L )} ] \cdot {e}^{- {αλ}_{n}^{2} τ} \}$$

1. A computer-implemented method for determining an internal temperature of a battery, the method comprising:
obtaining an initial temperature condition of the battery indicative of battery temperature at an initial time;
receiving current data indicative of electrical current in the battery at a given time after the initial time, and receiving ambient temperature data indicative of ambient temperature associated with the battery at the given time;
determining a heat generation rate in the battery based on an internal resistance of the battery and on the received current data;
determining a temperature change of the battery at the given time from the initial time, the temperature change being determined based on the obtained initial temperature condition and the determined heat generation rate; and,
determining the internal temperature of the battery based on the determined temperature change and the received ambient temperature data.

2. A method according to claim 1, the method comprising obtaining an electro-thermal model describing the temperature change of the battery as a function of time in dependence on heat generation rate in the battery, wherein determining the temperature change of the battery at the given time comprises evaluating the electro-thermal model at the given time based on the obtained initial temperature condition and the determined heat generation rate.

3. A method according to claim 2, wherein the electro-thermal model describes the temperature of the battery as a function of distance from a core of the battery.

4. A method according to claim 3, wherein determining the internal temperature of the battery comprises evaluating the electro-thermal model at a given distance from the core less than a distance to a surface of the battery; optionally, wherein the temperature at the core of the battery is determined as the internal temperature of the battery.

5. A method according to claim 3, the method comprising determining a surface temperature of the battery at the given time, wherein determining the surface temperature comprises evaluating the electro-thermal model at a distance equal to a distance from the core to the surface of the battery to determine the temperature change of the surface of the battery at the given time from the initial time, and determining the surface temperature of the battery based on the determined temperature change of the surface and the received ambient temperature data.

6. A method according to claim 2, wherein the electro-thermal model includes a plurality of parameters describing electrical, thermal and geometric properties of the battery.

7. A method according to claim 6, wherein values of the plurality of parameters are obtained via a training stage for training the electro-thermal model to determine the internal temperature of the battery, wherein the values of the plurality of parameters are obtained using historical data for the battery.

8. A method according to claim 7, the method comprising performing the training stage, wherein training stage comprises:
initialising the plurality of parameters with initial values;
evaluating the electro-thermal model with the initial parameter values and with the historical data to obtain an estimated surface temperature of the battery over a given time period;
comparing the estimated surface temperature with a measured surface temperature of the battery over the given time period obtained from the historical data; and,
updating the initial values of the plurality of parameters based on a difference between the estimated and measured surface temperatures to obtain current values of the parameters.

9. A method according to claim 8, wherein the training stage comprises repeating steps of:
evaluating the electro-thermal model with the current parameter values and with the historical data to obtain the estimated surface temperature over the given time period;
comparing the estimated surface temperature with the measured surface temperature over the given time period; and,
updating the current values of the plurality of parameters based on the difference between the estimated and measured surface temperatures over the given time period, until a stop condition is satisfied.

10. A method according to claim 9, wherein the stop condition includes at least one of:
the evaluating, comparing and updating steps have been repeated a prescribed threshold number of times; and,
a difference between a sum of squared errors between the estimated and measured surface temperatures over the given time period is less than a prescribed threshold difference value.

11-17. (canceled)

18. A method according to claim 1, the method comprising determining the internal resistance of the battery, wherein the internal resistance is determined based on a voltage across the battery under a no discharge condition of the battery, a voltage across the battery under discharge, and the current in the battery during discharge.

19. A method according to claim 1, wherein the initial temperature condition is obtained as an average temperature of the battery at the end of a previous time period in which the internal temperature of the battery was determined.

20. A method according to claim 19, wherein the previous time period corresponds to a time period that the battery operated in a certain operational mode.

21. A method according to claim 1, wherein the initial time corresponds to a time at which the battery changes to operating in one operational mode from another operational mode.

22. A method according to claim 1, wherein the battery is a lithium ion battery.

23. A method according to claim 1, wherein the battery is part of an Uninterruptible Power Supply (UPS) system.

24. A method according to claim 1, the method comprising providing an output in dependence on the determined internal temperature; optionally, wherein the output comprises a warning if the determined internal temperature exceeds a prescribed threshold; further optionally, wherein the output comprises a control signal to automatically change an operational mode of the battery if the determined internal temperature exceeds the prescribed threshold.

25. A non-transitory, computer-readable storage medium storing instructions thereon that when executed by a processor cause the processor to perform a method according to claim 1.

26. A system for determining an internal temperature of a battery, the system comprising one or more processors being configured to:
obtain an initial temperature condition of the battery indicative of battery temperature at an initial time;
receive current data indicative of electrical current in the battery at a given time after the initial time, and receive ambient temperature data indicative of ambient temperature associated with the battery at the given time;
determine a heat generation rate in the battery based on an internal resistance of the battery and on the received current data;
determine a temperature change of the battery at the given time from the initial time, the temperature change being determined based on the obtained initial temperature condition and the determined heat generation rate; and,
determine the internal temperature of the battery based on the determined temperature change and the received ambient temperature data.

27. A system according to claim 26, wherein the system is implemented in at least one of:
a device comprising the battery;
an edge processing device;
a battery management system for monitoring operation of the battery.
